(19) United States
(12) Patent Application Publication
(10) Pub. No.: US 2006/0042558 A1
(43) Pub. Date: Mar. 2, 2006

(54) Window-mounted pet enclosure

(76) Inventor: Nanette Stephens, Sloatsburg, NY (US)

Correspondence Address: Hugh McTavish;McTavish Patent Firm, 429 Birchwood Courts, Birchwood, MN, 55110, US

(21) Appl. No.: 10/924,524

(22) Filed: Aug. 24, 2004

(51) Int. Cl. A01K 1/03; A01K 1/035

(52) U.S. Cl. 119/484

(57) ABSTRACT

The invention provides a window-mounted outdoor pet enclosure. The enclosure is mosquito-proof. It is open on the end, sides and ceiling to air flow. The pet enclosure includes an end, a floor, two sides, and a ceiling, all having mosquito-proof screen. The enclosure also has a frame adapted to fit in a window of a wall, the frame linked to the mosquito-proof screen of the floor, sides, and ceiling. The floor, sides, and ceiling are each at least 70% open to air flow.

### BACKGROUND

Most working adults with pets have to leave their pets unattended at home all day while they work. Most dogs and cats enjoy the outdoors and would enjoy access to outdoor air and the chance to view the outdoors while their human guardians are away. Even when pet owners are home, they would often like to allow their pets safe access to the outdoors without having to monitor them. Pet owners would also often like to allow their pets to pass from the indoors to the outdoors and back on their own initiative, without the need for the owner to let the pets in and out.

Apartment dwellers, in particular, often find it inconvenient to take their pets outdoors.

Certain products are available that facilitate safe access of pets to the outdoors. For instance, the KITTYWALK™ portable outdoor pet enclosure is mesh enclosure that rests on the ground, designed to allow pets access to the outdoors while being safely enclosed.

Several window-mounted pet enclosures have also been described. See for example, U.S. Pat. Nos. 6,722,315; 6,470,829; 5,890,455; 5,782,205; 5,522,344; 5,167,202; and 5,148,767.

However, the prior window-mounted enclosures generally are not as completely exposed to outdoor air flow as the pet may desire. Many of the enclosures allow access of insects to the pet in the enclosure and to the house through the enclosure. Many are also not as stable as would be desired. Some do not allow the pet freedom to travel from the house to the outdoor enclosure and vice versa at will.

Accordingly, a need exists for a new design for a window-mounted pet enclosure.

### SUMMARY

The invention provides an enclosure that mounts in a window and allows pets access to the outdoors in an enclosed, safe space. In particular embodiments, the enclosure is mosquito proof. Preferably the enclosure is substantially open to air flow on both sides, the end, and the ceiling, and optionally in the floor as well. By “open to air flow,” it is meant that the enclosure is substantially composed of mosquito-proof screen, with little space occupied by solid walls or solid supports that block air flow, and also block sunlight and the pet's view of the outdoors.

Preferably, the enclosure is mosquito-proof. The sides, ceiling, end, and floor comprise mosquito proof screen, which is linked to an enclosure frame that fits in a window frame of a wall of a building. The mosquito proof screen of the sides, ceiling, and floor can be linked to the enclosure frame directly or indirectly (e.g., linkage of the mosquito-proof screen of the floor to a solid support member that is part of the floor, which is directly linked to the enclosure frame). The enclosure, in some embodiments, is open to the indoors of the house or apartment, allowing the pet to freely enter and leave the enclosure.

In some embodiments, the enclosure is supported by legs that rest on the ground or on a generally horizontal surface below the window, such as a balcony floor or a roof that the window overlooks.

Accordingly, one embodiment of the invention provides a window-mounted outdoor pet enclosure that includes: (a) an end, a floor, two sides, and a ceiling, all comprising mosquito-proof screen; and (b) a frame adapted to fit in a window of a wall of a building, the frame linked to the mosquito-proof screen of the floor, sides, and ceiling. The end, sides, and ceiling are each at least 70% open to air flow; and the enclosure is mosquito-proof.

### BRIEF DESCRIPTION OF THE DRAWINGS

FIG. 1 is a side angle view of one embodiment of a pet enclosure of the invention.

FIG. 2 is a view of an embodiment of a pet enclosure of the invention having a cylindrical form.

FIG. 3 is a view of an embodiment of a pet enclosure of the invention supported by legs.

FIG. 4 is a view of an embodiment of a pet enclosure of the invention supported by a brace strucure against the wall of the building.

FIG. 5 is a view of an embodiment of a pet enclosure of the invention having a floor that includes a solid support with openings for water drainage.

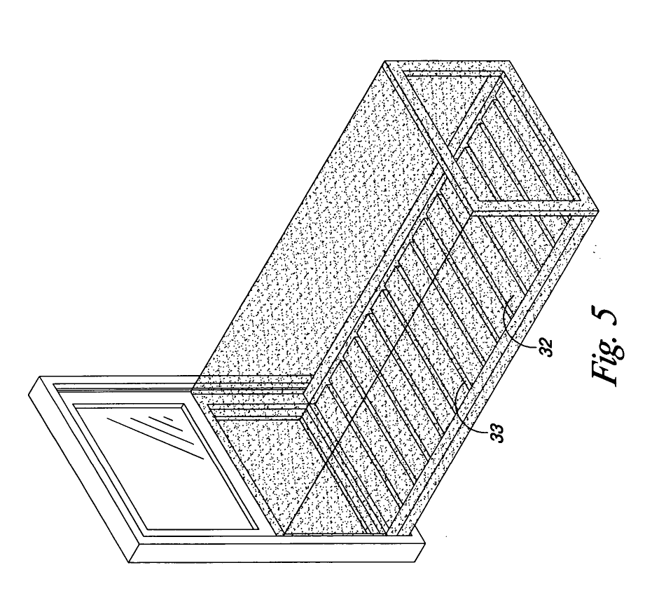

FIG. 6 is a view of an embodiment of a pet enclosure of the invention having an awning.

FIG. 7 is a view of a hoop adapted to compress two sheets of screen together to link the mosquito-proof screen of the floor, sides, and ceiling to the panel of mosquito proof screen in the frame.

### DETAILED DESCRIPTION

The invention provides a window-mounted outdoor pet enclosure that includes: (a) an end, a floor, two sides, and a ceiling, all comprising mosquito-proof screen; and (b) a frame adapted to fit in a window of a wall of a building, the frame linked to the mosquito-proof screen of the floor, sides, and ceiling; wherein the end, the two sides, and the ceiling are each at least 70% open to air flow; and the enclosure is mosquito-proof.

The enclosure, in particular embodiments, can be sealed from the house with, for instance, a solid wall mounted in the enclosure frame containing a door that can be opened for access to the enclosure.

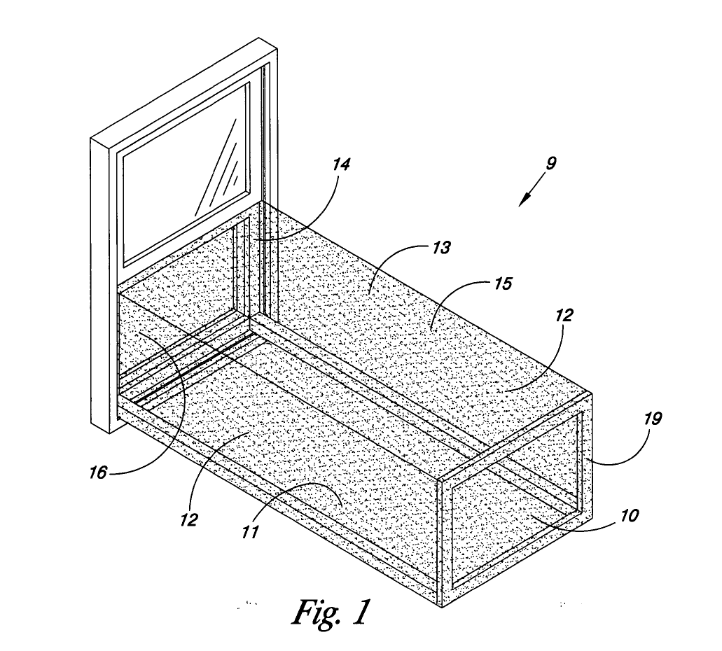

FIG. 1 shows one embodiment of the invention. The enclosure 9 includes a frame 14 that fits in the window. The frame is linked to a ceiling 13, two sides 12, and a floor 11, which are enclosed with an end 10. The embodiment shown in FIG. 1 is roughly square in cross-section. That shape is maintained by solid shaping supports 19. The shaping supports are narrow enough that they do not substantially block air flow or block sunlight or the pet's view from the inside of the enclosure. The ceiling 13, sides 12, floor 11, and end 10 each include mosquito-proof screen 15. The mosquito-proof screen typically completely encloses the ceiling, sides, floor, and ends, of the enclosure. But it could be discontinuous and attached to solid parts of the enclosure and still form a mosquito-proof enclosure. In FIG. 1, the frame forms an opening 16 through which the pet can pass to enter or leave the enclosure.

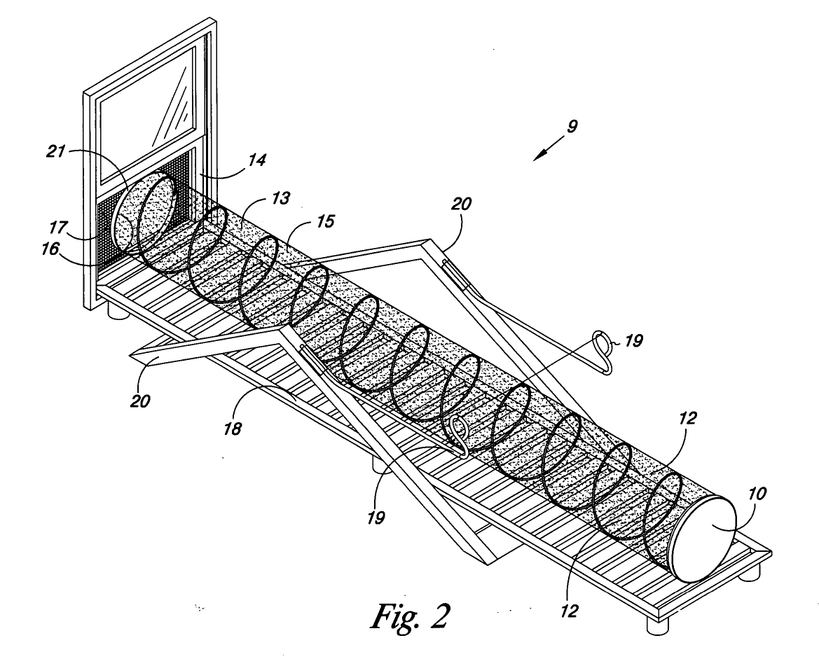

FIG. 2 depicts another embodiment of the invention. In FIG. 2, the enclosure is cylindrical. The cylindrical shape is maintained by a helical shaping support 19. The frame 14 circumscribes a panel 17 of mosquito-proof screen mounted in the frame. The panel 17 of mosquito-proof screen forms an opening 16 for the pet to pass through. The mosquito-proof screen of the ceiling, sides, and floor in this embodiment may be attached to the panel 17 with a device 21 of two hoops that can be pressed together to compress the screen of the ceiling, floor, and sides to the screen of the frame panel 17. An embroidery hoop has been used for this purpose. The compression of the two sheets of screen forms a mosquito-proof seal.

The embodiment shown in FIG. 2 can be created with a child's nylon play tunnel with the nylon walls removed. A mosquito-proof fine mesh rip-proof screen surrounds the entire tunnel and is attached to the helical shaping members of the tunnel with VELCRO™. The frame, with a mosquito-proof screen panel circumscribed by the frame, can be a standard adjustable window screen. A hole is created in the adjustable window screen, and the mosquito-proof screen of the window screen panel is attached to the mosquito-proof screen of the child's play tunnel with an embroidery hoop.

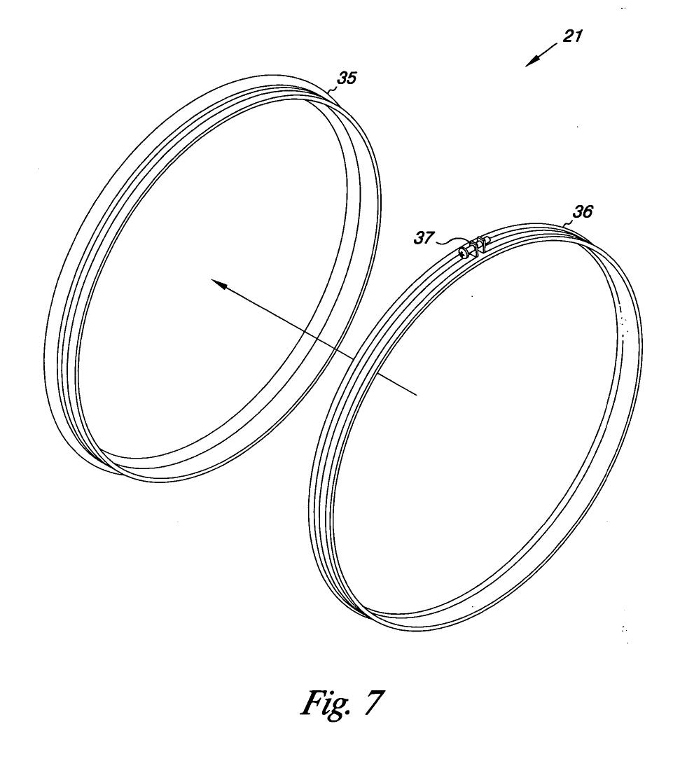

FIG. 7 shows an embroidery-hoop-type linkage 21 for coupling the screen of the floor, sides, and ceiling to the screen panel circumscribed by the frame in the window opening. One hoop 36 fits around another hoop 35 where the two sheets of screen are pressed together between the two hoops. An adjustable screw sinkage 37 allows hoop 36 to be contracted to form a tight seal over hoop 35.

In the embodiment shown in FIG. 2, the enclosure is supported on a separate support 18. The separate support may be, for instance, a free-standing table. Ir; a preferred embodiment, the table top of the separate support 18 is porous to water, so that rain water does not accumulate under or inside the enclosure. The table top can be, for instance, a nylon screen or a wire mesh or wood slats with spaces between them. The separate support could rest, for instance, on a roof, a balcony, or ground that the window in which the enclosure is mounted overlooks.

Where the enclosure is long (for instance 6 feet long) the enclosure may be connected to a sway support 20 that prevents the enclosure from excessive lateral movement. The sway support may for instance attach by hooks 19 to the ceiling of the enclosure.

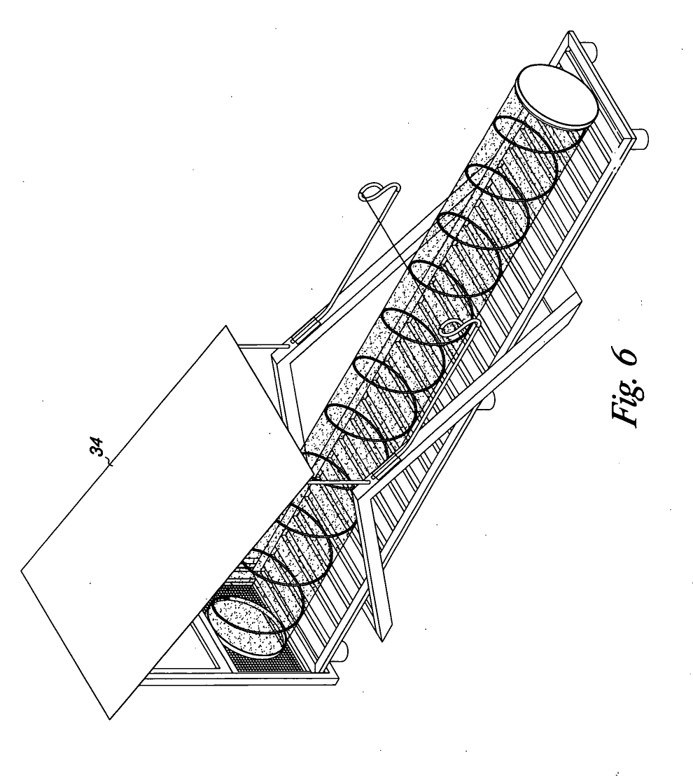

The sway support 20 may also be used to support an awning 34 that partially or completely shades the enclosure (FIG. 6). The awning may, for instance, be linked to the top of the outside window frame on the wall of the building and to the sway support 20. Preferably, the awning partially covers the enclosure, so the pet can choose whether to be in a shaded part of the enclosure or in a sun-exposed part of the enclosure.

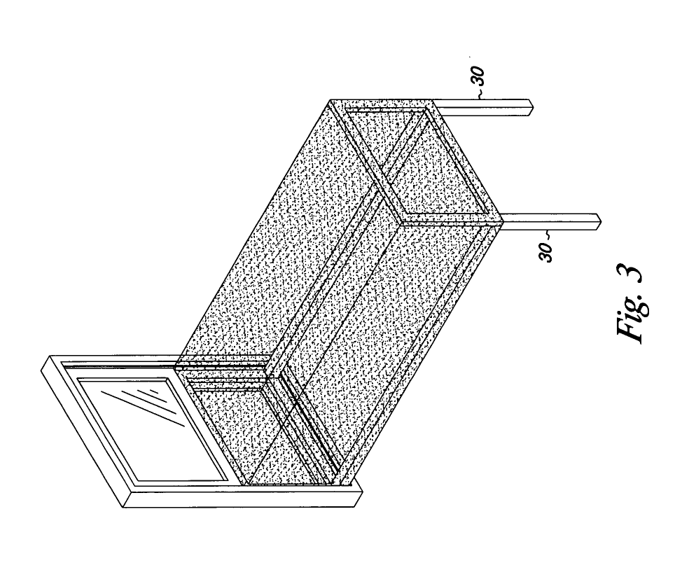

In another embodiment, shown in FIG. 3, the enclosure includes legs 30 for support linked to the floor of the enclosure. The legs 30 are preferably telescoping to allow for adjustment to various window heights and individually adjustable to adjust to irregular surfaces beneath the enclosure.

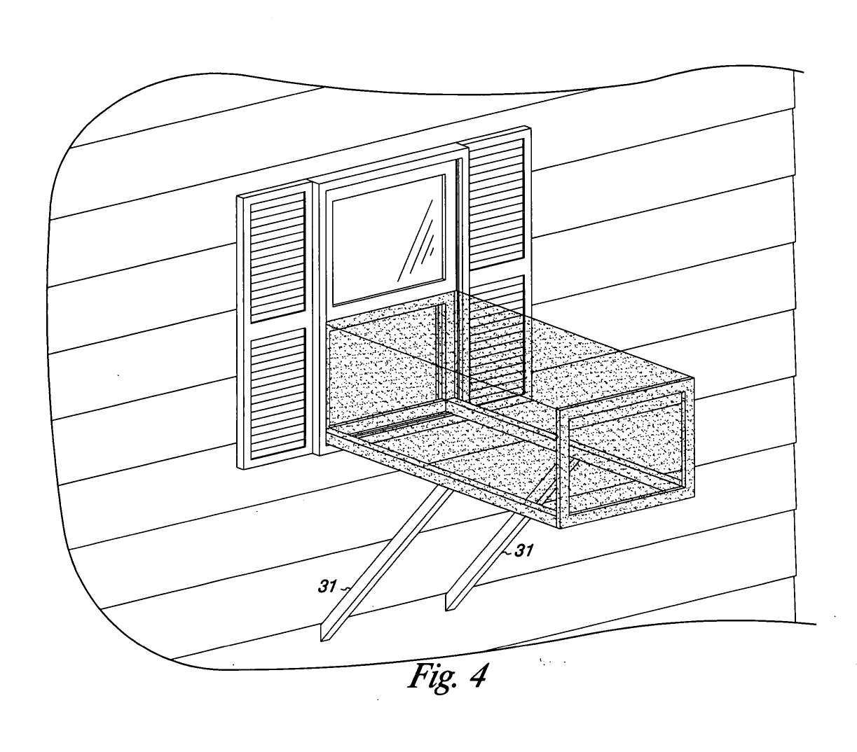

In another embodiment, shown in FIG. 4, the enclosure includes a brace structure 31 that is linked to the floor of the enclosure and adapted to engage the wall of the building to support the enclosure.

The enclosure frame 14 can be held in the window frame by any appropriate means. For instance, it may be held by pressure against the window frame. It may be held in the window frame by brackets. It may simply fit in the window frame and be held vertical by interaction with the rest of the enclosure structure, including legs 30, brace structure 31, or separate support 18 that supports the enclosure. The enclosure frame can be adapted to fit inside (i.e., toward the interior of the building) of a track frame in the window designed to hold a storm window and/or storm screen, where the storm window and storm screen are removed to make room for the pet enclosure. The enclosure frame 14 can also be adapted to fit in a track frame for the storm screen or storm window (e.g., with pegs that engage in the track).

In particular embodiments, the floor includes a solid support surface 32 having drainage openings 33 to allow water drainage. For instance, the solid support surface of the floor could be slats of wood or plastic, linked together with spaces between them to allow water drainage. The spaces should be large enough to allow immediate water drainage, but small enough to comfortably support the paws of a cat or dog. Alternatively the solid support surface could be a wire mesh with strength adequate to support the pet and spaces within the mesh large enough to allow immediate water drainage but small enough to support the paws of a cat or dog comfortably.

The mosquito-proof screen of the floor may be underneath the solid support surface of the floor. That keeps the paws of the pet off of the screen, reducing the chance the pet will tear the mosquito-proof screen. However, in another embodiment, the mosquito-proof screen is above the support surface of the floor.

To keep the pet from directly contacting the mosquito-proof screen, in some embodiments the enclosure can include a wire mesh in the sides, ceiling, and end, as well as optionally the floor. The wire mesh may be inside the mosquito-proof screen of the sides, ceiling, and end to prevent the pet from contacting and possibly damaging the screen. In other embodiments, the wire mesh is outside the mosquito-proof screen. In those embodiments, the wire mesh may serve to give shape to the enclosure.

In the enclosures, the end, both sides, and the ceiling are at least 70% open to air flow. The mosquito-proof screen is considered entirely open to air flow. Thus, by “70% open to air flow” it is meant that no more than 30% of the surface of the end, either side, or the ceiling is a solid surface that blocks air flow, such as a solid shaping support.

Some embodiments of the enclosure are collapsible. For instance, where the helical shaping member 19 is flexible, the enclosure shown in FIG. 2 can collapse along the longitudinal axis of the cylinder with the helical shaping member. Optionally, the ceiling, sides, and floor are detachable from the frame or the screen panel circumscribed by the frame.

The frame 14 or the screen panel 17 circumscribed by the frame form an opening 16 through which the pet can pass. The opening can be covered with a door (e.g., a pet door that the pet can open by pushing against it). But in preferred embodiments, the opening is uncovered.

The enclosure typically is entirely outside of the sliding window in the window frame. Thus, the house can be sealed from air flow from the enclosure by simply closing the window.

In one embodiment of the enclosure, the floor, the two sides, and the ceiling form a cylinder.

In one embodiment, the floor includes a support surface having drainage openings for water. “Support surface” as used herein refers to a structure distinct from the mosquito-proof screen that supports the pet's weight.

In one embodiment, the support surface is a solid support surface. “Solid support surface” as used herein refers to a support surface that is continuous over a width greater than about 3 mm. The solid support surface can be, for instance, straps (flexible or rigid); wood, plastic, or metal slats; or a wood, plastic or metal sheet with holes for water drainage.

In another embodiment, the support surface of the floor is a wire mesh support surface. “Wire mesh” as used herein refers to a mesh structure where the wire of the mesh has a substantially greater diameter than the fibers of the mosquito-proof screen and smaller than about 3 mm. The wire may be of any suitable material, including metal and plastic. The wire mesh support surface supports the pet's weight on the floor.

Optionally, the floor includes no solid support surface or wire mesh support surface, and the pet's weight is supported by the mosquito-proof screen or by a separate stand 18 on which the floor rests.

In particular embodiments, the floor support surface is above the mosquito-proof screen of the floor. This has the advantage of supporting the pet's paws above the mosquito-proof screen of the floor to prevent contact with the screen and reduce or eliminate the risk the pet will tear the screen.

In particular embodiments, the floor support surface is below the mosquito-proof screen of the floor.

In particular embodiments, the enclosure includes a plurality of legs linked to and supporting the floor.

In particular embodiments, the panel of mosquito-proof screen is mounted in the enclosure frame, the panel forming an opening sufficiently large for a pet to pass through; wherein the panel of mosquito-proof screen is linked to the floor, sides, and ceiling.

In particular embodiments of the invention, the floor is at least 70% open to air flow.

In particular embodiments of the invention, the end, the two sides, and the ceiling are each at least 90%, more preferably at least 95%, open to air flow.

In particular embodiments, the enclosure includes an awning mounted above the ceiling of the enclosure and adapted to shield at least a portion of the enclosure from rain and sun.

In particular embodiments, the enclosure is adapted to rest on a separate support.

In particular embodiments, the enclosure includes a brace structure linked to the floor and adapted to engage the wall of the building to support the enclosure.

In particular embodiments, the enclosure frame is a fixed size. In other embodiments, the enclosure frame is adjustable in size.

In particular embodiments, the panel of mosquito-proof screen in the frame is linked to the mosquito-proof screen of the floor, two sides, and ceiling by a means for compressing two sheets of screen together.

In particular embodiments, the enclosure is compressible. The enclosure may be compressible to occupy a volume less than 50%, less than 30%, or less than 10% of the volume of the enclosure in its expanded form.

The enclosures described herein are best suited for cats and small dogs (i.e., dogs less than about 40 pounds, preferably less than about 30 pounds, more preferably less than about 20 pounds). The enclosures, if they are large enough to accommodate larger dogs, may also be used by larger dogs. The enclosures art also suitable to be used and enjoyed by other pets, including rabbits, mice, hamsters, guinea pigs, rats, and birds.

What is claimed is:

1. A window-mounted outdoor pet enclosure comprising:
an end, a floor, two sides, and a ceiling, all comprising mosquito-proof screen;
a frame adapted to fit in a window of a wall of a building, the frame linked to the mosquito-proof screen of the floor, sides, and ceiling;
wherein the end, sides, and ceiling are each at least 70% open to air flow; and
wherein the enclosure is mosquito-proof.

2. The enclosure of claim 1 wherein the floor, the two sides, and the ceiling form a cylinder.

3. The enclosure of claim 1 wherein the floor further comprises a support surface having drainage openings for water.

4. The enclosure of claim 3 wherein the support surface of the floor is above the mosquito-proof screen of the floor.

5. The enclosure of claim 3 wherein the support surface of the floor is below the mosquito-proof screen of the floor.

6. The enclosure of claim 3 wherein the support surface is a solid support surface.

7. The enclosure of claim 3 wherein the support surface is a wire mesh support surface.

8. The enclosure of claim 1 further comprising:
a plurality of legs linked to and supporting the floor.

9. The enclosure of claim 1 wherein a panel of mosquito-proof screen is mounted in the frame, the panel forming an opening sufficiently large for a pet to pass through; and
wherein the panel of mosquito-proof screen is linked to the floor, sides, and ceiling.

10. The enclosure of claim 9 wherein the panel of mosquito-proof screen in the frame is linked to the mosquito-proof screen of the floor, two sides, and ceiling by a means for compressing two sheets of screen together.

11. The enclosure of claim 1 wherein the floor is at least 70% open to air flow.

12. The enclosure of claim 1 wherein the end, the two sides, and the ceiling are each at least 90% open to air flow.

13. The enclosure of claim 1 further comprising an awning mounted above the enclosure and adapted to shield at least a portion of the enclosure from rain and sun.

14. The enclosure of claim 1 wherein the enclosure is adapted to rest on a separate support.

15. The enclosure of claim 1 further comprising:
a brace structure linked to the floor and adapted to engage the wall of the building to support the enclosure.

16. The enclosure of claim 1 wherein the frame is a fixed size.

17. The enclosure of claim 1 wherein the frame is adjustable in size.

18. The enclosure of claim 1 wherein the enclosure is collapsible.
